(19) United States
(12) Patent Application Publication
(10) Pub. No.: US 2011/0290918 A1
(43) Pub. Date: Dec. 1, 2011

(54) PROCESS FOR EFFICIENT MILLING OF PARTICLES TO A PREDETERMINED PARTICLE SIZE AND/OR PARTICLE SIZE DISTRIBUTION

(75) Inventors: Michael MELICK, Lebanon, OH (US); Lisa CLAPP, Cincinnati, OH (US); Paul MERCHAK, Loveland, OH (US); Russell SCHWARTZ, Cincinnati, OH (US)

(73) Assignee: Sun Chemical Corporation, Parsippany, NJ (US)

(21) Appl. No.: 13/117,081

(22) Filed: May 26, 2011

Related U.S. Application Data
(60) Provisional application No. 61/348,364, filed on May 26, 2010.
(60) Provisional application No. 61/439,150, filed on Feb. 3, 2011.

(51) Int. Cl. B02C 23/18

(52) U.S. Cl. 241/15

(57) ABSTRACT

The present invention is a process for efficiently milling particles to a predetermined particle size and/or particle size distribution. The process includes feeding a fluid dispersion containing particles to be milled into a chamber. The process also includes contacting a fiber milling assembly in said chamber with said particles. Further, the process includes milling said particles for less than or equal to 40 minutes.

### CROSS REFERENCE TO RELATED APPLICATIONS

This application claims the benefit of U.S. Provisional Patent Application Nos. 61/348,364, filed on May 26, 2010, and 61/439,150, filed on Feb. 3, 2011. Both provisional patent applications are hereby incorporated by reference for all purposes as if fully set forth herein. This application is also related to a US Non-provisional patent application concurrently filed on May 26, 2011, titled “FIBER BASED MILLING DEVICE AND METHOD”, naming Michael Melick, Lisa Clapp, Paul Merchak and Russell Schwartz as inventors of the application (Attorney Docket Number 33148.00862.US03). The contents of the concurrently filed application is incorporated by reference herein.

### BACKGROUND OF THE INVENTION

1. Field of the Invention

The present invention generally relates to process for the efficient milling of particles to a predetermined particle size and/or particle size distribution.

2. Discussion of the Related Art

Milled particles may used in a wide variety of applications. In particular, milled particles with a small particle size and/or particle size distribution are considered to be useful in the imaging industry. These properties in milled particles also are considered to be highly desirable in pigments.

Milling typically involves repeated collisions of solid particles suspended in a slurry, or a liquid dispersion, with a milling media. The milling media are freely dispersed in a milling zone of a milling chamber. The repeated, random collision of particles to be milled with milling media by way of impact, shear and cavitation forces over a predetermined period of time causes the particles to break or de-aggregate. By so doing, the particle size is reduced. Once the particles are reduced to a predetermined particle size and/or particle size distribution, the fluid dispersion containing the particles is separated from the milling media by any conventional filtration step to recover the final product.

While conventional milling processes may be capable of milling particles to a desired particle size, these techniques have drawbacks associated with long milling times. This may be caused by the milling media employed to mill particles. Accordingly, throughput associated with conventional milling processes generally tends to be low.

For at least these reasons, there is a need for a milling process that efficiently mills particles to a desired particle size and/or particle size distribution in less time.

### SUMMARY OF THE INVENTION

It is an object of the present invention to develop a process for milling particles to a desired particle size and/or particle size distribution in less time. It is another object for contacting particles with a fiber milling media.

One advantage of the present invention may be attributed to a pigment contact defined by the geometry of the fiber milling media employed in a milling device with respect to the particles to be milled.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

To achieve these and other advantages, and in accordance with the purpose of the present invention, as embodied and broadly described, there includes a process for the efficient milling of particles. The present invention is capable of producing particles having a reduced particle size and/or particle size distribution in a short period of time. The process may be used in any milling device. In a preferred embodiment, the process may be used in a fiber based milling device such as the one described in a related US Non-provisional patent application concurrently filed on May 26, 2011, titled “FIBER BASED MILLING DEVICE AND METHOD”, naming Michael Melick, Lisa Clapp, Paul Merchak and Russell Schwartz as inventors of the application (Attorney Docket Number 33148.00862.US03.

The fiber based milling device may comprise a fiber assembly including one or more fibers. The fiber assembly may be secured to a shaft by a securing mechanism. Alternatively, the fiber assembly may be secured to another component disposed in the fiber based milling device, or to an inner wall of the device.

The fiber based milling device may include loose “cut” fibers in a chamber. In other words, the fibers may be freely dispersed within a chamber in order to mill particles to a desired particle size and/or particle size distribution.

It is to be understood that both the foregoing general description and the following detailed description are exemplary and explanatory and are intended to provide further explanation of the invention as claimed.

### BRIEF DESCRIPTION OF THE DRAWINGS

The accompanying drawing, which is included to provide a further understanding of the invention and is incorporated in and constitutes a part of this specification, and together with the description serve to explain the principles of the invention.

In the Drawing:

FIG. 1 is a graph comparing particle sizes using different milling media.

### DETAILED DESCRIPTION OF THE ILLUSTRATED EMBODIMENTS

Reference will now be made in detail to exemplary embodiments of the present invention, examples of which are illustrated in the accompanying drawings.

An exemplary milling process is one capable of producing particles with a small particle size and/or particle size distribution. The milled particles may be considered useful in product inks. In particular, the particles may be used to produce inks and toners in digital printing applications.

Particles with a small particle size and/or particle size distribution are also considered to be useful in other industries. These industries may include, but are not limited to, inks, coatings, paints, fluids for electronic displays, food, drink, cosmetics, liquids, powders, petroleum products, or other industrial materials of virtually any type.

An advantage of the exemplary process is attributed to the production of a flow pattern which induces high levels of shear and cavitation. The high levels of shear and cavitation may result in highly effective and efficient particle size reductions of the particles.

Another advantage of the process is the contact between the fiber milling media and the particles to be milled. That is, the geometric size and shape of the fiber or fibers helps break down the particles to be milled. It has been shown that the arrangement and geometry of the fibers inside the milling chamber significantly contributes to a final product with a desired particle size distribution.

As discussed above, the process may be used in any milling device. In particular, the process is carried out in a fiber based milling assembly, as disclosed in a related US Non-provisional patent application concurrently filed on May 26, 2011, titled “FIBER BASED MILLING DEVICE AND METHOD”, naming Michael Melick, Lisa Clapp, Paul Merchak and Russell Schwartz as inventors of the application (Attorney Docket Number 33148.00862.US03).

In one exemplary embodiment, the process may be employed in a fiber based milling device having a milling zone defined as a milling chamber. The fiber based milling device may also include a shaft. The shaft may directly receive power from an electric motor. Alternatively, the shaft may indirectly receive power from an electric motor Preferably, the motor speed may be controlled by an autotransformer or a variable frequency drive.

In another exemplary embodiment, the fiber based milling device may include one or more fiber assemblies disposed within a chamber. Each of the fiber assemblies may include one or more fibers. The fiber or fibers may be made of a similar material. Alternatively, the fiber or fibers may be made from combinations of materials. For example, the fibers may be made of synthetic polymeric fibers, ceramic fibers, metal fibers and/or natural resin fibers.

An exemplary list of synthetic polymeric fibers may include polyolefins (e.g. polyethylene, polypropylene, high and ultra high molecular weight polyethylene and polypropylene); polyamide (e.g. nylon 6-6 and 6-12); aramid (e.g. Kevlar, Nomex, Twaron, etc.); polyester; polycarbonate; polystyrene; polyacrylic; polyphenylene; monofilament of nylon and other proprietary blends; and other polymeric materials or combinations of materials.

Polymeric fibers may also comprise core/shell polymers; surface treated polymers; and interpenetrating networks.

An exemplary list of metal fibers may include steel; aluminum; alloys, such as stainless steel 302, 304, 316, and other variants; brass; bronze; or other alloys containing copper, nickel, zinc, and other metals or a combination of metals. Metal fibers may also comprise surface treated metals; coated metals; and surface hardened metals.

An exemplary list of ceramic fibers may include, for example, metal oxides of aluminum, silicon, boron, or a combination of ceramics. Ceramic fibers may also comprise, but are not limited to, surface treated ceramics and surface hardened ceramics.

The natural fibers may include cellulosic types.

In an exemplary embodiment, the fibers may be formed in any shape, size or level of stiffness. The individual fibers may be comprised of a single type, or any combination of different types of shapes, sizes and/or stiffnesses. The fibers may be round. Alternatively, the fiber may be non-round. In an embodiment where the fibers are non-round, the fibers may include, but are not limited to, the following dimensions: oblong; 2-sided; 3 sided (e.g. triangular or tri-lobal); 4-sided (e.g. square, rectangular; rhombus; trapezoidal); star shaped (with 2, 3, 4, 5, 6 or more sides); 5 or more sided; and other polygon geometries.

In an exemplary embodiment, the fibers may be solid. Alternatively, the fibers may be hollow.

In another exemplary embodiment, the fibers may be conductive. Alternatively, the fibers may be non-conductive.

In another embodiment, the fibers may be linear. Alternatively, the fibers may be nonlinear. Examples of non-linear fibers include curved, twisted or crimped fibers. In yet a further embodiment, the fibers may be both linear and non-linear.

In yet another embodiment, the fibers may be rigid. Alternatively, the fibers may be flexible. In a further embodiment, the fibers may be semi flexible. Configurations of the semi-flexible fibers include bent, looped, or multi-lobed.

For purposes of this disclosure, the fibers may have a uniform or non-uniform thickness. The thickness of the fibers may range from 0.5 to 10,000 microns. The fibers more preferably have a thickness from about 0.5 microns to about 2,000 microns. In an even more preferred embodiment, the thickness may be about 20 to 400 microns.

The fibers may be any length. The fiber length may be limited by the chamber in which they will be used. That is, the fibers may depend upon the scale of production. Fibers may fall into either of the major industry classifications of short “discontinuous fibers” or they can be cut from long “continuous” fibers. In an exemplary embodiment, the fibers may be longer than the dimensions of the chamber. This is possible in view of the flexibility of the fibers to bend and curve in order to contour to an inner wall of the chamber.

For purposes of this disclosure, combinations of different fiber types may be interspersed or separated in the fiber milling assembly. Groups of fibers may be comprised of high or low packing density. The fibers may also be comprised of a uniform or non-uniform packing density, or any combination thereof.

Further, the fiber assembly or assemblies containing one or more fibers may be patterned in any spatial orientation within the chamber. In one embodiment, the fiber or fibers may be perpendicular with respect to the shaft. Alternatively, the fiber or fibers may be disposed parallel to the shaft. The fiber or fibers may be disposed at virtually any angle relative to the shaft or at multiple or random angles. In another embodiment, the fibers are disposed at any angle relative to a plate located inside the chamber. The fiber or fibers may be regularly spaced. The fibers may be irregularly spaced. Fibers may be patterned in a spiral arrangement. Fibers may be patterned in a row. Fibers may be pattered in plural rows. Fibers may be longitudinally patterned. Fibers may be axially patterned. Fibers may irregularly be patterned whereby large fibers are followed by small fibers. Any combination of fibers may be used as a pattern suitable to contact the particles to be milled so as to efficiently reduce the particles to a desired particle size and/or particle size distribution.

The fluid medium is composed of the particles to be milled. The fluid medium may also comprise particles already milled that have been recirculated through the milling device which will be discussed in further detail below. The fluid medium may include a fluid such as water. Alternatively, the fluid medium may include a gas. Further, the fluid may alternatively contain any mixture of materials capable of transporting the particle to be milled through the milling device.

The fluid medium or dispersion may include solvents, pigments, resins, defoamers, surfactants and dispersants. These may include, but are not limited to, hydrocarbon resin varnish, alkyd varnish, magiesol 47 solvent, carbon black pigment, direct black 19 dye based colorant, high purity isopropyl alcohol, glycerin, deionized water, C.I. Pigment Yellow 14, urea crystal, ammonia, proxel GXL biocide, Surfynol DF110D defoamer and Joncryl 674 resin.

In a further embodiment, the fluid medium containing the particle is reciruclated through the milling device until a desired particle size and/or particle size distribution is achieved. Many different methods and arrangements may be employed to recirculate the particle through the milling device. Recirculation may be conducted by continued agitation of the particles by an impeller located in the fluid medium chamber to propel the particle from the outlet of the milling device to an inlet of the milling device. Alternatively, recirculation may also be performed by pumping the particle through tubes that connect the inlet and the outlet of the fiber milling device.

### Example 1

A cowles type disperser blade on a Premiere “Laboratory Dispersator” Model 2000 high speed disperser is replaced with an Indco MP153A laboratory impeller. A fiber laced rubber mat measuring 3 inches wide by 2.5 inches wide high is wrapped around the circumference of the ¾ inch diameter rotating shaft and affixed with standard plastic zipper type interlock ties. The fibers interlaced to the rubber mat are Vectran HT Fiber 2.5 denier filament yarn. The fibers are interlaced into the mat to maximize the density of the fiber arrangement. The fibers are woven in a loop pattern such that the loops reach within 1/16 of an inch of the pipe mixing chamber.

The disperser shaft with fibers attached thereto is encapsulated in a cylindrical pipe arrangement surrounded by a 3 inch tall section of 304 stainless steel wire 0140 mesh (30 mesh per linear inch) cloth. The bottom of the mesh cylinder is supported by a thin stainless steel ring cut from a length of 1.5 inch 304 stainless steel pipe. The mesh is secured to the thin ring with a stainless steel hose clamp.

A primary construction feature of the basket configuration is a custom fabricated stainless steel plate affixed to the mixer head. Onto this plate is welded a 10 in. length of 1.5 in. 304 stainless steel pipe. About one half inch above the mesh basket, the pipe preferably is cut with three ¾ in. wide by 3 in. tall slots which provide a path for fluid recirculation. The upper end of the mesh screen cylinder is secured to an outer wall of the pipe with a stainless steel hose clamp.

In operation, the mechanism is lowered into a standard stainless steel laboratory vat measuring 4.5 in. D×6 in. H. A pigment, water and surfactant are mixed prior to milling with a Cowles® blade mixer for 40 minutes at 3000 RPM. The Premiere disperser is adjusted to 3,000 RPM with a Staco Energy Products 120V Variable Autotransformer. The mill is run until the desired particle size and/or particle size distribution is achieved.

### Example 2

The Premiere disperser shaft is fitted with a custom made 316 stainless steel shaft collar measuring 3.5 in. high and 1⅝ in. in diameter. Preferably, the shaft collar is cut in two equal halves in the direction of the axis of the disperser shaft. The collar can be rejoined along its length by a vertical series of custom tapped and beveled points to accommodate seven 1¼ in. machine screws on both sides.

Inside the halved shaft collars is placed a high density of the Vectran fibers described above. The fibers are cut to a length of 2⅛ in. This will place the fiber end within 1/16 in. of the milling chamber wall. The fibers are held in place with a small amount of temporary adhesive. For example, two side adhesive transparent tape can be used. The collar halves are re-joined such that the collar bottom aligns with the bottom of the ¾ in. disperser shaft.

The above mentioned components are lowered into a standard plastic laboratory 500 milliliter graduated cylinder measuring 2 in. in diameter and cut to 10 in. in height. A pigment, water and surfactant are mixed prior to milling with a Cowles® blade mixer for 40 minutes at 3000 RPM. The Premiere disperser is adjusted to 3000 RPM with a Staco Energy Products 120V Variable Autotransformer and the mill is allowed to run until the desired particle size and/or particle size distribution is achieved.

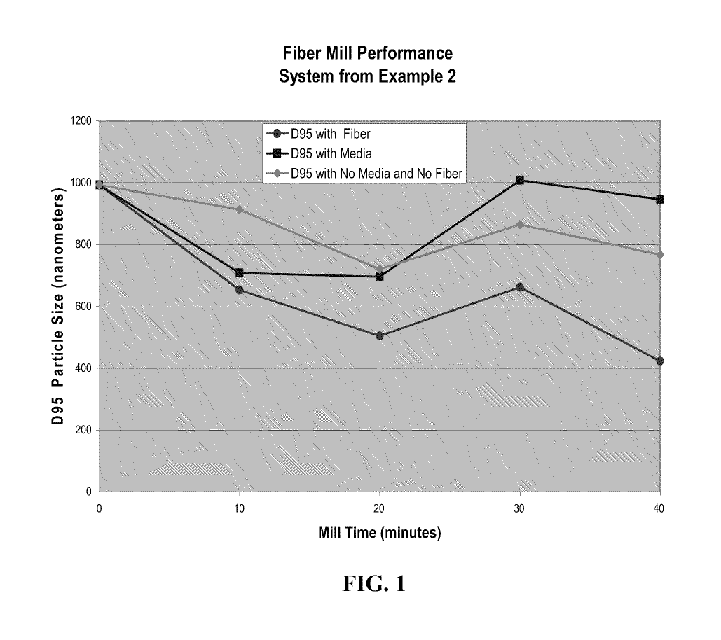

The process exhibits exceptional results when compared to conventional milling processes. The D₉₅ particle size data as shown in FIG. 1 discloses the particle size at which 95% of the sample particles are below the indicated D₉₅ value. The effectiveness of the fibers was evaluated by running the apparatus in two control modes. The first mode involved replacing the fibers with an equal volume of 200-300 micron diameter Polystyrene Beads. The second mode involved removing the fibers and milling media as a control experiment against the dispersing capacity of the rotating shaft sleeve itself.

As illustrated in FIG. 1, the fiber based mill reduced the D₉₅ value both faster and further than the two control experiments. As expected, the media based experiment at first reduced the particle size faster than the base apparatus with no media or fibers until a milling point was reached whereby re-agglomeration resulted in bigger particles. Such re-agglomeration is a common observation in these systems.

As further shown in the graph, the D95 particle size value of the fiber based mill between approximately 15 and 25 minutes is less than about 600 nm. Even more preferably, at approximately 20 minutes, the D95 particle size value is less than about 500 nm. In addition, the fiber based system ended up at a lower D95 particle size value of about 423 nanometers versus 767 nanometers microns for the base apparatus and 946 nanometers for the media based device after approximately 40 minutes of milling time.

### Example 3

The Premiere “Laboratory Disperator” Model 2000 ¾ in. disperser shaft is adapted with circular cuts of 304 stainless steel perforated plate. The plate is manufactured by the McNichols Company of Tampa, Fla. and is commercially available in 18 gauge thickness with 1/16 in. diameter perforations. The plates are spaced ⅛ in. apart. This plate is custom cut into two 1⅜ in. diameter circles. Vectran HT 2.5 denier filament yarn fibers as supplied by Engineered Fibers Technology of Shelton, Conn. are woven between the plates such that the distance between the plates is 2¼ in. The perforated plate is fitted to the disperser shaft and secured with standard snap rings below the top plate and above the bottom plate such that the vertical fibers are immobilized relative to the vertical length of the disperser shaft. The fiber/plate arrangement is situated such that the bottom perforated plate aligns with the bottom of the disperser shaft.

A primary construction feature of the pipe configuration is a custom fabricated stainless steel plate affixed to the mixer head. The plate is welded to a 10 in. length of 1.5 in. 304 stainless steel pipe. One half inch above the mesh basket, the pipe is cut with three ¾ in wide by 3 in tall slots (two slots are shown) which provides a path for fluid recirculation induced by a 1 in. impeller having three blades.

The disperser shaft with the vertical fiber/plate construction attached is encapsulated in a cylindrical arrangement by a 3 in. tall section of 304 stainless steel wire 0140 mesh (30 mesh per linear inch) cloth. The bottom of the mesh cylinder is supported by a thin stainless steel ring cut from a length of 1.5 in. 304 stainless steel pipe. The mesh is secured to the thin ring with a stainless steel hose clamp that compresses a bend in the mesh against the steel ring and the steel pipe housing.

In operation, the mechanism is lowered into a standard stainless steel laboratory chamber measuring 4.5 in. D×6 in. H. A pigment water and surfactant are mixed prior to milling with a Cowles® blade mixer for 40 minutes at 3000 RPM. The Premiere disperser is adjusted to 3000 RPM with a Staco Energy Products 120V Variable Autotransformer (not shown) and the mill is allowed to run until the desired particle size and/or particle size distribution is achieved.

### Example 4

The standard agitator on the drive shaft of an Eiger brand MKII Mini 250 horizontal bead mill is removed and replaced with a custom fabricated spiral brush as manufactured by Spiral Brushes, Inc. of Stow, Ohio. The spiral brush consists of a central ⅞ in. ID by 1⅜ in. OD shaft sleeve mount with a standard 3/16 in.× 3/32 in. keyway. The shaft sleeve mount is surrounded by and attached to a solid metallic coil with a diameter of ⅜ in. Slightly crimped fibers constructed of 0.006 in. diameter 304 stainless steel have been securely embedded in the ⅜ in. metallic coil and the coil is wound in a spiral fashion around the shaft sleeve forming a final overall brush diameter of 3⅛ in. and overall length of 2¾ in. The fibers form a very dense continuous fiber mat containing approximately 55 individual fibers per square centimeter. The specified overall diameter of the brush is chosen to yield a very small gap between the brush and mill chamber no larger than 1/32 in. The brush is securely mounted to the shaft with the standard agitator end cap and screw.

The particles to be milled are prepared according to the following procedure. 1300 grams of a pre-grind pigment dispersion mixture is prepared by blending 403 grams of hydrocarbon resin varnish, 344.5 grams of phenolic resin varnish, 195 grams of BHT preservative, 130 grams of alkyd varnish and 247 grams of Magiesol 47 white oil on a Cowles® blade mixer at 1000 RPM for 20 minutes. 156 grams of phthalocyanine crude that has been dry ball milled is slowly added to the resin/oil blend and then mixed for 40 minutes at 3000 RPM on the Cowles® blade mixer.

In operation, 650 grams of liquid dispersion is introduced to the product inlet funnel and the mill is started and the rotational speed is set to 4500 RPM. Fluid is propelled to the chamber by the standard feed screw and passes into contact with the fibers after passage through a gap formed between the pump impeller and the feed ring. The pumping rate is variable with respect to the rotational speed of the shaft. With the product outlet closed, the milled fluid recirculates via the product recirculation pipe to the product inlet funnel. At all times during the process, the mill cooling jacket is supplied with an ethylene glycol/water mixture set to maintain a product temperature of 40° C. The product is sampled at 30 minutes and the milling and recirculation process continues for two hours. At this time the mill is de-energized and the final product is recovered through the product outlet port. For comparative purposes, the standard agitator on the drive shaft is used with the milling chamber charged with 200 milliliters of 1.0 mm magnesia stabilized zirconia media manufactured by Zircoa of Solon, Ohio. The remaining 650 grams of pre-grind material is added to the product inlet funnel. The mill is operated again at 4500 RPM with a product sample taken at 30 minutes and a final sample taken at about two hours. Color analysis with a Spectroeye™ spectrophotometer/densitometer manufactured by Gretag Macbeth of New Windsor, N.Y. indicates a product with an identical color strength value.

### Example 5

In this example, a Premiere “Laboratory Dispersator” Model 2000 high speed disperser is fitted with a specially machined ¾ diameter by 11 long rotating shaft. The shaft is modified by preferably machining six evenly spaced ⅜ in. holes with 5/16 in. counter opposing set screws. A 2.2 gram bundle of Vectran HT™ fiber supplied by Engineered Fibers Technology of Shelton, Conn. is cut as strands to a length of 2½ in. and is secured at the center of the bundle in each of the six mounting holes by the set screws. The Vectran HT™ fiber is supplied as spooled strands of filament yarn. Each strand contains approximately 50 individual continuous fibers of 2.5 denier measured optically at about 15 micron diameter and a published tensile strength of 2,850 to 3,340 MPa.

The shaft with fibers attached thereto is encapsulated in a cylindrical arrangement constructed from an 11 in. section of 2 in. ID 316 stainless steel pipe. There is a 2½ in. fiber bundle length set to provide a ¼ in. of excess length at the pipe wall to enhance high speed shear effects. The top of the pipe enclosure is attached to the mixer head with a thin circular plate welded to the pipe and drilled with a bolt pattern matching that of the mixer motor such that the entire assembly is securely bolted to the mixer body in conjunction with the mixer motor. The pipe enclosure contains two diametrically opposed ¼ in. diameter by ½ in. long screw inserts threaded into the pipe at the approximate mid-point level of each fiber bundle. The screws provide interference to the rotating fiber bundles to prevent any undesirable matting of the fiber bundle.

A pre-grind pigment dispersion mixture is prepared by wetting a powdered carbon black pigment in the presence of a dye based colorant and water within a chamber acted upon by a high speed Cowles® blade mixer. First, a one liter stainless steel chamber is charged with 336.0 grams of deionized water followed by 150.0 total grams of Direct Black 19 dye based colorant (at 15% dye strength) and 1.2 grams of Proxel™ GXL preservative added under moderate agitation with a 1.5 inch diameter Cowles® blade mixer at 500 RPM for no less than three minutes. Next, the agitation rate is increased to 2,500 RPM and 112.8 grams of Cabot Emperor™ 1,800 carbon black powder is added slowly to the mixture over a period of not less than 5 minutes. Finally, the agitation is increased to 4,000 RPM for a period of at least 40 minutes and the mixture is visually inspected for homogeneity.

In this experiment, the fiber milling chamber is lowered less than one third of the way into a standard stainless steel laboratory vessel measuring 5 in. D×7 in. H. The pre-grind material described above is added to the chamber. The modified Premiere Disperator is adjusted to 5,000 RPM with a Staco Energy Products 120 Volt Variable Autotransformer (not shown). The fluid level preferably is below the milling device (i.e., no immersion). A Cole Parmer MasterFlex™ peristaltic pump is adjusted to a flow rate of 220 ml/min and the dispersion material is pumped to a level just above the top fiber bundle in the milling chamber allowing the dispersion material to fall by gravity back into the dispersion vessel. The material is allowed to recirculate for 30 minutes prior to a quality evaluation.

The material produced in this example is evaluated against two materials of identical composition and a pre-grind method finished in two conventional milling devices. Three hundred grams of the product standard is produced in a 50 ml Dispermat® SL Horizontal Bead Mill running at 50% pump speed and 3000 RPM for 30 minutes with 1.2 mm ceramic media. Another conventional media comparison at a comparative volume scale is produced with 600 grams of dispersion in a 250 ml Eiger Machinery Mini Mill running at 4000 RPM for 30 minutes with 0.8-1.0 mm ceramic media. The particle size measurements are recorded in Table 1 from a Microtrac Nanotrac® particle size analyzer. As shown below, the Fiber mill was capable of reducing the particle size distributions better than the Eiger mill and a standard mill.

For example, the measured particle size of the final product using the Fiber mill is significantly less than when an Eiger mill and a standard mill are used. For example, D₅₀, D₉₅ and D₁₀₀ values of the particles after 30 minutes of milling in the fiber milling device were 39 nm, 134 nm and 344 nm, respectively. By contrast, the D₅₀, D₉₅ and D₁₀₀ values after 30 minutes of milling in the Standard mill were 65 nm, 186 nm and 344 nm. In addition, the D₅₀, D₉₅ and D₁₀₀ values after 30 minutes of milling in the Eiger mill were 45 nm, 169 nm and 486 nm, respectively. Further, the difference in measured particle size values after 15 minutes of milling in the Fiber mill were improved over the Eiger mill device.

As shown in Table 1, the ratio of the D₅₀/D₉₅, D₅₀/D₁₀₀, and D₉₅/D₁₀₀ measured particle size values are improved when using the Fiber Mill versus conventional milling devices. The Fiber Mill and the Eiger mill were each run at mill times of 15 and 30 minutes. At 15 minutes, the particles milled in the Fiber mill had a D₅₀/D₉₅ value of 0.26, a D₅₀/D₁₀₀ value of 0.11, and a D₉₅/D₁₀₀ value of 0.41. At 30 minutes, the particles milled in the Fiber mill had a D₅₀/D₉₅ value of 0.29, a D₅₀/D₁₀₀ value of 0.11, and a D₉₅/D₁₀₀ value of 0.39. By contrast, at 15 minutes of milling particles in the Eiger mill, the particles had a D₅₀/D₉₅ value of 0.28, a D₅₀/D₁₀₀ value of 0.08, and a D₉₅/D₁₀₀ value of 0.28. At 30 minutes of milling, the particles milled in the Eiger mill had a D₅₀/D₉₅ value of 0.27, a D₅₀/D₁₀₀ value of 0.09, and a D₉₅/D₁₀₀ value of 0.35. Based on the test data, at least the D₉₅/D₁₀₀ ratio of particles milled in a fiber milling device is improved over particles milled in an Eiger mill device. As known in the art, distribution curves exhibiting a narrower width are considered to be indicative of better mill performance.

TABLE 1
Forced Recirculation Fiber Mill vs. Conventional Mill Particle Size
Comparison

| | | Measured Particle | | | |
|---|---|---|---|---|---|
| | Mill Time | Size in Nanometers | | | |
| Mill | (min) | Mean Value | D₅₀ | D₉₅ | D₁₀₀ |
| Standard | 30 | 81 | 65 | 186 | 344 |
| Eiger Mill | 15 | 75 | 53 | 191 | 687 |
| Eiger Mill | 30 | 64 | 45 | 169 | 486 |
| Fiber Mill | 15 | 64 | 44 | 169 | 409 |
| Fiber Mill | 30 | 52 | 39 | 134 | 344 |

Additionally, an analysis of large particle count is provided in Table 2 as recorded from a Particle Sizing Systems Accusizer 780 system. An equal number of particles were used in each test. As shown, the number of particles sizes above 500 nm per gram of dispersion is significantly greater when a standard or Eiger mill are used as the milling device during a mill time of 30 minutes. Specifically, there were 6.782×10⁷ particles per gram of pigment greater than 500 nm in the sample using a standard mill. There were 4,426 particles per gram of pigment greater than 500 nm in the sample using an Eiger mill. These larger particles are a primary cause of print head blockage. By contrast with the Standard and Eiger mill, the fiber mill produced only 804 particles per gram greater than 500 nm.

TABLE 2
Forced Recirculation Fiber Mill vs. Conventional Mill Large Particle
Comparison

| | | Particle Count > (500 nm) |
|---|---|---|
| Mill | Mill Time (min) | per gram of pigment |
| Standard | 30 | 6.782 × 10⁷ |
| Eiger Mill | 30 | 4426 |
| Fiber Mill | 30 | 804 |

Finally, a sample in each of the mills were measured for solids content and converted to an inkjet formula at equal solids content for comparison of color characteristics. The formulation included the following:

| Carbon Black Dispersion | 29.7% (approximate based on solids) |
|---|---|
| High purity isopropyl alcohol | 0.5% |
| Glycerine | 2.5% |
| Deionized Water | 67.3% (approximate based on solids) |
| | 100% |

The ink formulation is drawn down with a #6 Meyer rod on Hammermill paper and measured for color properties on a Datacolor 110™ spectral analyzer.

As shown below in Table 3, the results of the inkjet formulation, as disclosed above, are milled for 30 minutes. The results are compared using an Eiger mill and a Fiber mill. The Fiber mill appears to have an improved color strength of 103.89% versus 101.35% using the Eiger mill. Moreover, the DL* value, which represents the lightness/darkness color difference, reveals that the fiber milled sample has the lowest value. Hence, the fiber milled samples are the darkest. The final products exhibit significantly better, and ultimately, unexpected results when processed through the fiber milling device of the present invention.

TABLE 3
Forced Recirculation Fiber Mill vs. Conventional Mill Color Value
Comparison

| | Mill | | | | |
|---|---|---|---|---|---|
| | Time | Color | | | |
| Mill | (min) | Strength % | DL* | Da* | Db* |
| Eiger | 30 | 101.35 | −0.12 | 0.05 | 0.09 |
| Fiber | 30 | 103.89 | −0.63 | 0.01 | −0.08 |

### Example 6

In this example, a Hockmeyer HCPN Micro Mill of immersion style construction is charged with a 40 milliliter volume of manually cut polymeric fiber. The fiber is a commonly available blend of nylon polymers sold as fishing line with a tensile strength of 0.103 Newtons per square millimeter. The fiber is cut manually into small pieces with an average length of 2.9 mm and an average diameter of 0.43 mm.

The preparation of the pre-grind particles includes 2,600 grams of a pre-grind pigment dispersion mixture prepared by combining 2078.5 grams of SUNBRITE™ Yellow 14 from press cake containing 47.50% solids and 52.5% water. The following are then added to the dispersion mixture: 321.1 grams of Joncryl 674 Resin, 101.1 grams of urea crystals, 91.1 grams of aqueous ammonia, 5.2 grams of Proxel GXL biocide, and 2.6 grams of Surfynol DF110D defoamer. The ingredients are mixed with a Cowles® blade mixer for 40 minutes at 3,000 RPM.

The performance of the fiber mill was compared with a convention mill device. Specifically, one kilogram of a pre-grind material is introduced to the HCPN mill chamber and the milling head containing the cut fibers is lowered into the pre-grind mixture with the impeller 2 inches from the bottom of the milling chamber. The mill speed is adjusted to 5,000 RPM and allowed to run for a period of two hours.

For comparative purposes, the cut fibers are replaced with a 40 milliliter volume of 200-300 micron diameter polystyrene media. Again, 1000 grams of the well mixed pre-grind material is milled in identical fashion to the cut fiber experiment at 5,000 RPM for two hours. Finally, a standard sample is prepared from milling 600 grams of the pre-grind material in a 250 ml Eiger Machinery Mini Mill running at 4,000 RPM for 30 minutes with 200 milliliters of 1.0 mm magnesia stabilized zirconia media.

The solids content of each sample is measured and dispersion aliquots containing equal solid weights are placed in 50 grams of Deep Base Flat paint as supplied by Porter Paints of Pittsburgh Pa. The samples are shaken on a Hauschild centrifugal SpeedMixer™ for four minutes at 3,000 RPM and drawn down with a #30 Meyer rod on a 3NT-4 Drawdown Sheet as supplied by the Leneta Company of Mahwah, N.J. The pigment strength results are read on a Spectroeye™ spectrophotometer/densitometer manufactured by GretagMacbeth of New Windsor, N.Y.

According to Table 4, the relative pigment strength using cut fibers in a Hockmeyer NCPN device is better than using standard or polystyrene media. Specifically, the relative pigment strength is 102.2. % using cut fibers.

TABLE 4
Cut Fiber Mill vs. Conventional Mill Pigment Strength Comparison

| | | Media | | | |
|---|---|---|---|---|---|
| | | Chamber | Batch | Milling | Relative |
| | | Volume | Size | Time | Pigment % |
| Sample | Mill Type | (ml) | (grams) | (min) | Strength |
| Standard | Eiger Mill | 250 | 650 | 30 | 100.0 |
| Polystyrene | Hockmeyer | 40 | 1000 | 120 | 92.8 |
| Media | HCPN | | | | |
| Cut Fiber | Hockmeyer | 40 | 1000 | 120 | 102.2 |
| | HCPN | | | | |

It will be apparent to those skilled in the art that various modifications and variations can be made in the present invention without departing from the spirit and scope of the invention. Thus, it is intended that the present invention cover the modifications and variations of this invention provided they come within the scope of the appended claims and their equivalents.

What is claimed is:

1. A process for milling particles with a fiber based milling device to a predetermined particle size comprising:
feeding a fluid dispersion containing particles to be milled into a chamber of said device;
contacting a fiber assembly in said chamber with said particles for less than or equal to 40 minutes; and
recovering milled particles with said predetermined particle size.

2. The process according to claim 1, wherein the contacting step is less than or equal to 40 minutes.

3. The process according to claim 2, wherein the milling step is less than or equal to 20 minutes.

4. The process according to claim 3, wherein the milling step is less than or equal to 15 minutes.

5. The process according to claim 1, wherein the particle size is less than about 600 nm.

6. The process according to claim 5, wherein the particle size is less than about 500 nm.

7. The process according to claim 1, wherein a D₉₅/D₁₀₀ value of said milled particles is greater than 0.35.

8. The process according to claim 1, wherein said contacting step comprises impacting said fiber assembly with a pressurized fluid containing said particles.

9. The process according claim 1, wherein said contacting step comprises impacting said particles with a movable fiber milling assembly.

10. A process for milling particles with a fiber based milling device to a predetermined particle size distribution comprising:
feeding a fluid dispersion containing particles to be milled into a chamber of said device;
contacting a fiber assembly in said chamber with said particles for less than or equal to 40 minutes; and
recovering milled particles with said predetermined particle size distribution.

11. The process according to claim 10, wherein the contacting step is less than or equal to 40 minutes.

12. The process according to claim 11, wherein the milling step is less than or equal to 20 minutes.

13. The process according to claim 12, wherein the milling step is less than or equal to 15 minutes.

14. The process according to claim 10, wherein the particle size is less than about 600 nm.

15. The process according to claim 14, wherein the particle size is less about 500 nm.

16. The process according to claim 10, wherein a D₉₅/D₁₀₀ value of said milled particles is greater than 0.35.

17. The process according to claim 10, wherein said contacting step comprises impacting said fiber assembly with a pressurized fluid containing said particles.

18. The process according to claim 10, wherein said contacting step comprises impacting said particles with a movable fiber milling assembly.
